(19) United States
(12) Patent Application Publication
(10) Pub. No.: US 2013/0159734 A1
(43) Pub. Date: Jun. 20, 2013

(54) Power Management Methods for System on a Chip

(71) Applicant: Yang Pan, Shanghai (CN)

(72) Inventor: Yang Pan, Shanghai (CN)

(21) Appl. No.: 13/329,347

(22) Filed: Dec. 19, 2011

(51) Int. Cl. G06F 1/26

(52) U.S. Cl. 713/300

(57) ABSTRACT

Methods for reducing power consumption of a system on a chip (SOC) are disclosed. The system comprises multiple subsystems. Each of the subsystems comprises a first voltage regulator and a second voltage regulator that may be placed closely on a layout. The first voltage regulator is coupled to at least one performance sensor. A controller initiates a power optimization program that determines minimal output voltage of the first voltage regulator for achieving minimal acceptable performances of the performance sensors. Determined output voltage is duplicated to a second voltage regulator to supply power for system components of the subsystem.

### CROSS-REFERENCE TO RELATED APPLICATIONS

Not applicable

### BACKGROUND

1. Field of Invention

This invention relates to integrated circuits, specifically to power management methods for integrated circuits.

2. Description of Prior Art

Various embodiments described herein relate to power management of an integrated circuit. Power consumption in an integrated circuit is a function of the supply voltage provided to the integrated circuit. For example, many digital logic circuits represent a binary one and a binary zero as the supply voltage and ground voltage, respectively. As digital logic evaluates during operation, signals frequently transition fully from one voltage to the other. Therefore, the power consumed in an integrated circuit is dependent on magnitude of the supply voltage relative to the ground voltage. Reducing the supply voltage generally leads to reduced power consumption, but also impacts the speed at which digital circuits operate and thus may cause malfunction of the integrated circuit.

Additionally, as transistor geometries have continued to decrease in size, manufacturing process induced statistical variations in critical dimensions, such as, for example, a gate length of metal oxide semiconductor field effect transistor (MOSFET) is playing more critical rule in performances of the integrated circuit and therefore yield of a product. A designer has to take such variation into consideration when an integrated circuit is designed. Such an approach often leads to a conservative performance specification.

### SUMMARY OF THE INVENTION

It is therefore an object of the present invention to provide power management methods that utilize powers more efficiently by operating subsystems of system on chip (SOC) under minimal supply voltages that still provides satisfactory functionalities and performances.

In one embodiment, a subsystem of a SOC comprises a first programmable voltage regulator coupled to one or more performance sensors, a second programmable voltage regulator coupled to system components of the subsystem and a controller coupled to the voltage regulators and to the performance sensors. When the subsystem starts to be operational, the controller sends a signal to the regulators to generate an initial output voltage as a bias voltage for the performance sensors and for the system components.

The controller starts immediately a power (bias voltage) optimization program. The output voltage of the first voltage regulator is reduced progressively to a minimal level at which the performance sensors deliver minimal acceptable performances. The performance sensors further include performance indicators that comprise limits. The limits of the performance indicators are correlated closely to performance limits of the subsystem. The minimal output voltage of the first voltage regulator is subsequently duplicated by the second voltage regulator by the controller as the bias voltage for the system components of the subsystem.

In another embodiment, SOC comprise a centralized controller. Each of the subsystems shares the controller to optimize its power consumption.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a diagram illustrating an exemplary subsystem of the SOC including a power reduction module.

FIG. 2 is a flowchart illustrating a power optimization program of the exemplary subsystem as shown in FIG. 1.

FIG. 3 is a flowchart illustrating operation of the exemplary subsystem as shown in FIG. 1.

FIG. 4 is a schematic diagram illustrating an exemplary SOC with multiple subsystems, wherein each of the subsystems comprises a controller.

FIG. 5 is a schematic diagram illustrating an exemplary SOC comprising multiple subsystems, wherein a centralized controller is shared by all subsystems.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

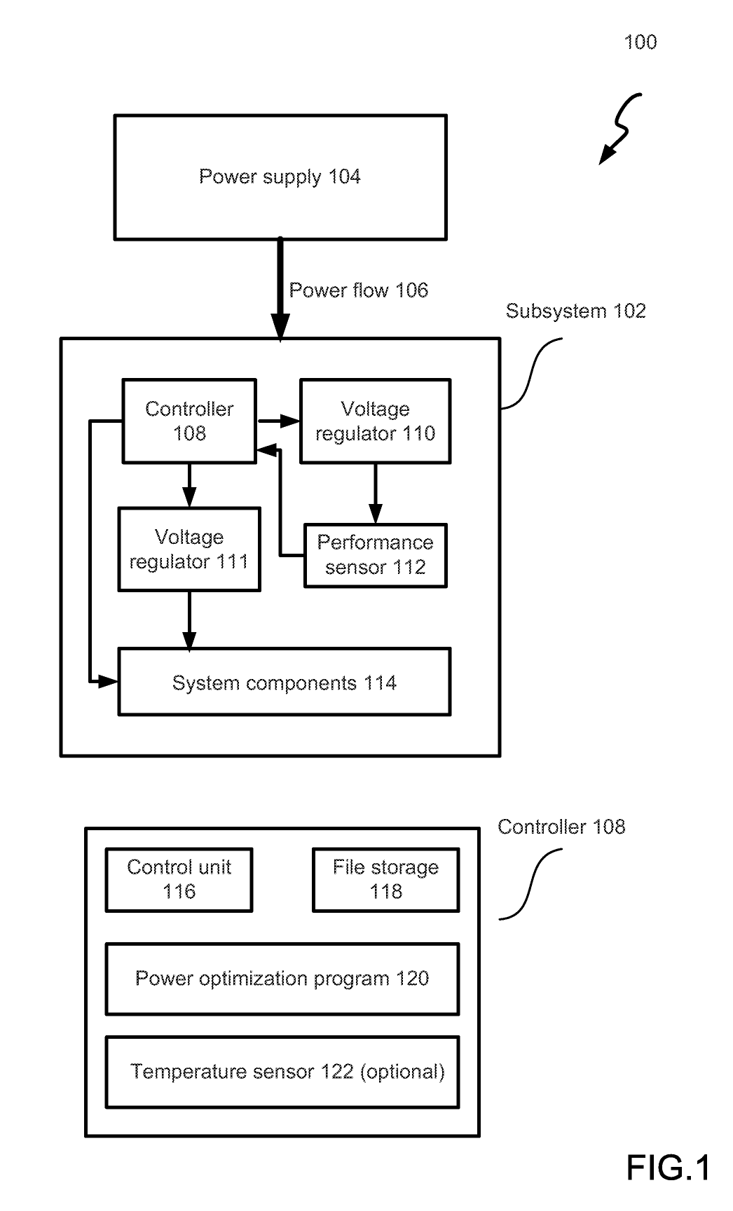

FIG. 1 illustrates an exemplary system for reducing power consumption of a subsystem of a SOC. A SOC may comprise a microcontroller, a storage unit, an input and output unit and a communication unit as subsystems. System 100 comprises a subsystem 102. Subsystem 102 may be anyone of the subsystems of the SOC. System 100 further comprises a power supply 104 to provide electrical power for subsystem 102. Power flow 106 is from power supply 104 to subsystem 102.

Subsystem 102 further comprises a controller 108. Controller 108 may be the same controller as the SOC′. Controller 108 may also be an independent microcontroller. Controller 108 may even be a dedicated controller for power management only. Controller 108 may comprise a special purpose processor. Controller 108 may further comprise ASIC and FPGA types of circuits. Controller 108 may comprise hardware, software and firmware. Controller 108 further comprises a control unit 116, a file storage unit 118 and a power optimization program 120. File storage unit 118 may comprise a nonvolatile semiconductor memory, such as, for example, a flash memory or a MRAM. File storage unit may further comprise a cache including a SRAM or a DRAM. Power optimization program 120 may be stored in file storage unit 118. Program 120 may be read out by control unit 116 and be executed accordingly.

Subsystem 102 further comprises a first programmable voltage regulator 110 and a second programmable voltage regulator 111. Outputs of the voltage regulators may be controlled by controller 108. In one aspect, the output of the voltage regulator may take any value in a predetermined range controller by controller 108. In another aspect, the output of the regulators may comprise a number of selectable values by controller 108. Controller 108 sends a control signal and a reference signal to set the output of the regulator. In one implementation, voltage regulator 110 and voltage regulator 111 may be identically designed and are placed in close proximity limited only by design rules of layout. Such an implementation will enable the same reference signals from controller 108 for regulator 110 and regulator 111 to generate almost identical outputs. It should be noted the minimal output voltage of regulator is typically related to a reference signal (e.g., voltage or current). Controller 108 may measure the reference signal corresponded to the minimal output voltage and record the reference signal rather than the output voltage. Controller 108 may record the reference signal directly. Controller 108 may also record the reference signal after the signal is converted to a digital signal by an analog to digital converter (not shown in FIG. 1).

However, the present inventive concept does not limit that regulator 110 and regulator 111 are identically designed and are placed closely. In another implementation, regulator 110 and regulator 111 may be one programmable voltage regulator with two or more outputs. Controller 108 may include a means of determining the output of the voltage regulator directly by measuring the output voltage and by employing a feedback loop to sustain it.

The first voltage regulator 110 is further coupled to a performance sensor 112. Performance sensor 112 may comprise one or multiple measurement circuits that generate one or more performance indicators. The performance indicators generated by performance sensor 112 shall closely represent performances of system components 114. Performance indicators may include limits that are closely correlated to performance limits of subsystem 102. For example, performance sensor 112 may include a ring oscillator. A frequency of the ring oscillator represents speed performance of system components 114. Performance sensor 112 may also include a current sensor for measuring saturation and leakage currents of a NMOSFET and a PMOSFET. Performance sensor 112 may include measurement circuit for measuring speed performance of a critical path of a digital integrated circuit. Performance sensor 112 may be designed to demonstrate certain “look-ahead” behaviors as a performance predictor. For example, the gate lengths of MOSFET's of a speed testing circuit may be intentionally sized up by a predetermined amount (e.g., 2% up). The gate lengths of a leakage testing circuit may be intentionally sized down by another predetermined amount (e.g., 2% down). Performance sensor 112 is not a portion of system components 114 and does not provide functionalities of subsystem 102 other than as a portion of a power management module.

The first voltage regulator 110 generates an output voltage as an initial bias voltage for performance sensor 112. Controller 108 then initiates the execution of power optimization program 120. The output of 110 will reduce progressively and performance indicators of performance sensor 112 are measured accordingly. The output voltage (or the related reference signal) that corresponds to limits of the performance indicators is recorded by controller 108. One or more performance indicators may be selected, depending on an operation mode of subsystem 102. The operation mode may depend on operation frequency of subsystem 102. The operation mode may depend on functionalities that subsystem 112 is delivering. In an exemplary case, the output voltage is recorded if anyone of the selected performance indicators is reaching its limit.

In one aspect, the output voltage (or the reference signal) and its current operation mode may be recorded in a data file. The data file may be stored in file storage unit 118. In another aspect, temperature of operation of the chip may also be recorded. Controller 108 may generate output voltages for the regulators according to the data file. Controller 108 may decide if power optimization program 120 will be executed. According to one embodiment, output voltages for different operation modes and at different temperatures are determined during a functional or final testing event. The output voltages and other operational parameters are stored in the data file in file storage unit 118. Controller 108 generates output voltage for the voltage regulators according to the data file for a selected operation mode at an operating temperature.

In another aspect, a temperature sensor 122 is included in controller 108. Temperature sensor 122 may also be external to controller 108 and is coupled to controller 108. Temperature sensor 122 may even be a portion of performance sensor 112. All such variations will fall into the scope of the present invention. It should be noted that inclusion of temperature sensor 122 is optional and is not essential for operations of various embodiments and should not limit the scope of the present invention. Operating temperature of subsystem 102 is measured by temperature sensor 122 in a predetermined frequency. Controller 108 may monitor the performance indicators of performance sensor 112, the operation mode of subsystem 102 and the operating temperature closely and adjust output voltages of the voltage regulators accordingly to ensure that subsystem 102 is operated with minimal power consumption.

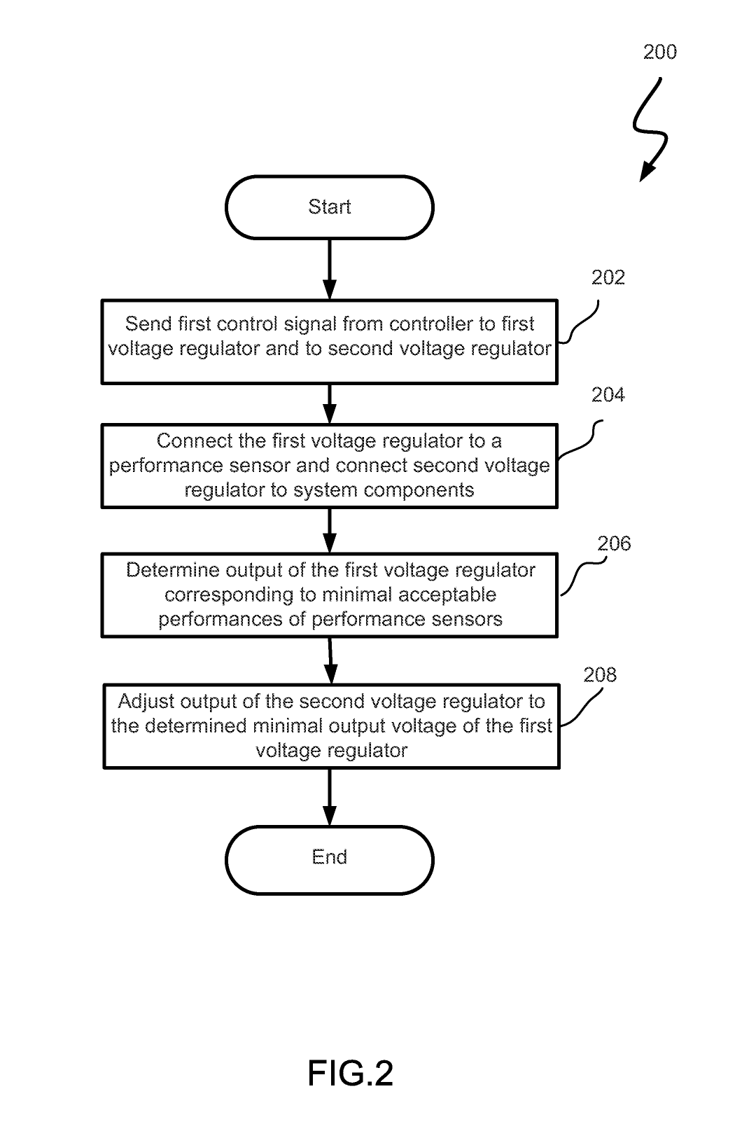

FIG. 2 is a flowchart illustrating operation of power optimization program 120 of the exemplary subsystem as shown in FIG. 1. Process 200 starts with step 202 that a control signal is sent from controller 108 to the first voltage regulator 110 and to the second voltage regulator 111 to generate initial output voltages for the voltage regulators. The output of the first voltage regulator 110 is coupled to performance sensor 112 and the output of the second voltage regulator is coupled to system components 114 (204). The output of the first voltage regulator 110 is subsequently reduced progressively and the performance indicators of performance sensor 112 are measured accordingly. The output voltage of the first voltage regulator 110 is determined when the minimal acceptable performances represented by the performance indicators are delivered by performance sensor 112 (206). The output voltage of the second voltage regulator 111 is adjusted to the same level of the first voltage regulator 110 that corresponds to the minimal acceptable performances of the performance sensor 112.

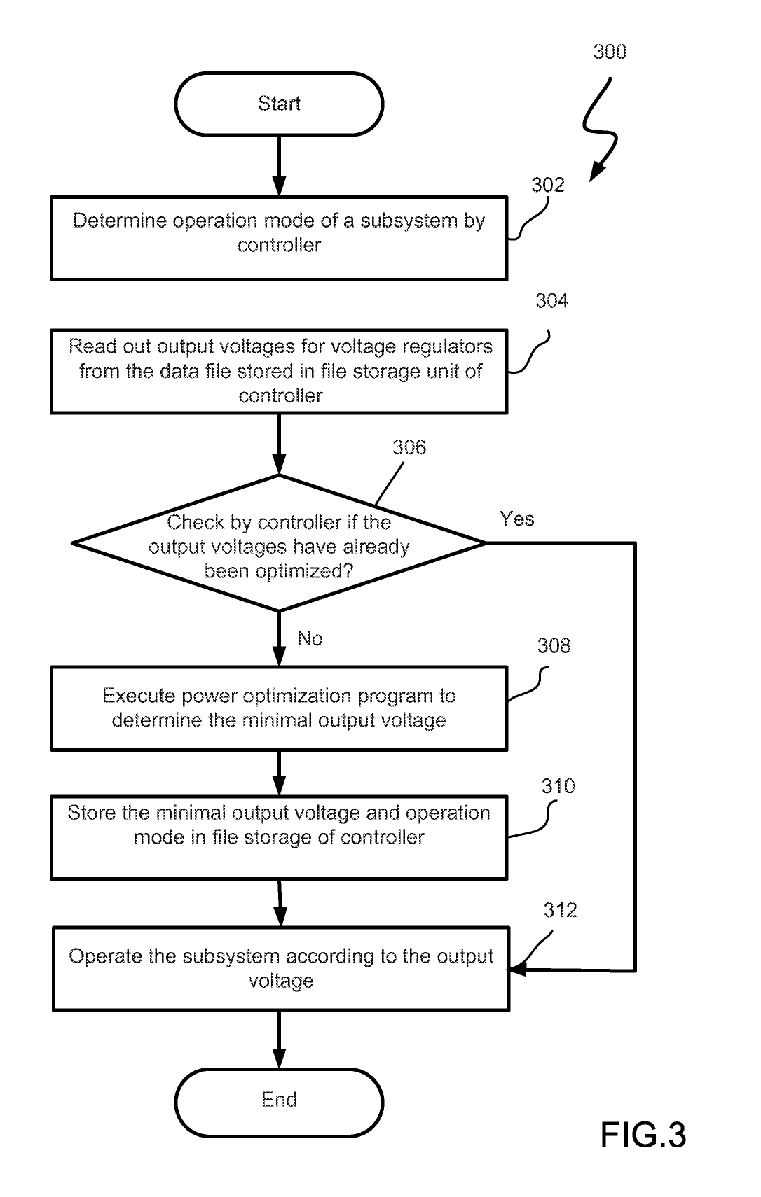

FIG. 3 is a flowchart illustrating operation of the exemplary subsystem as shown in FIG. 1. Process 300 starts with step 302 that an operation mode and an operating temperature (optional) are determined by controller 108. Initial output voltages for the first voltage regulator 110 and for the second voltage regulator 111 are read out from the data file stored in the file storage unit 118 of controller 108 (304). Controller 108 checks if the output voltages have been optimized previously either during functional or during final tests or during previous operations of subsystem 102 (306). If result is positive, subsystem 102 will be operated according to the recorded output voltage (312). Controller 108 may make a decision to optimize the output voltages even if power optimization program 120 has been executed previously in order to verify and to optimize further the power consumption. Otherwise, power optimization program 120 will be executed by controller 108 to obtain minimal output voltage (308). After executing program 102, the minimal output voltage will be stored in the file storage unit 118 (310). Subsystem 102 will be operated according to the minimal output voltage generated from the second voltage regulator 111.

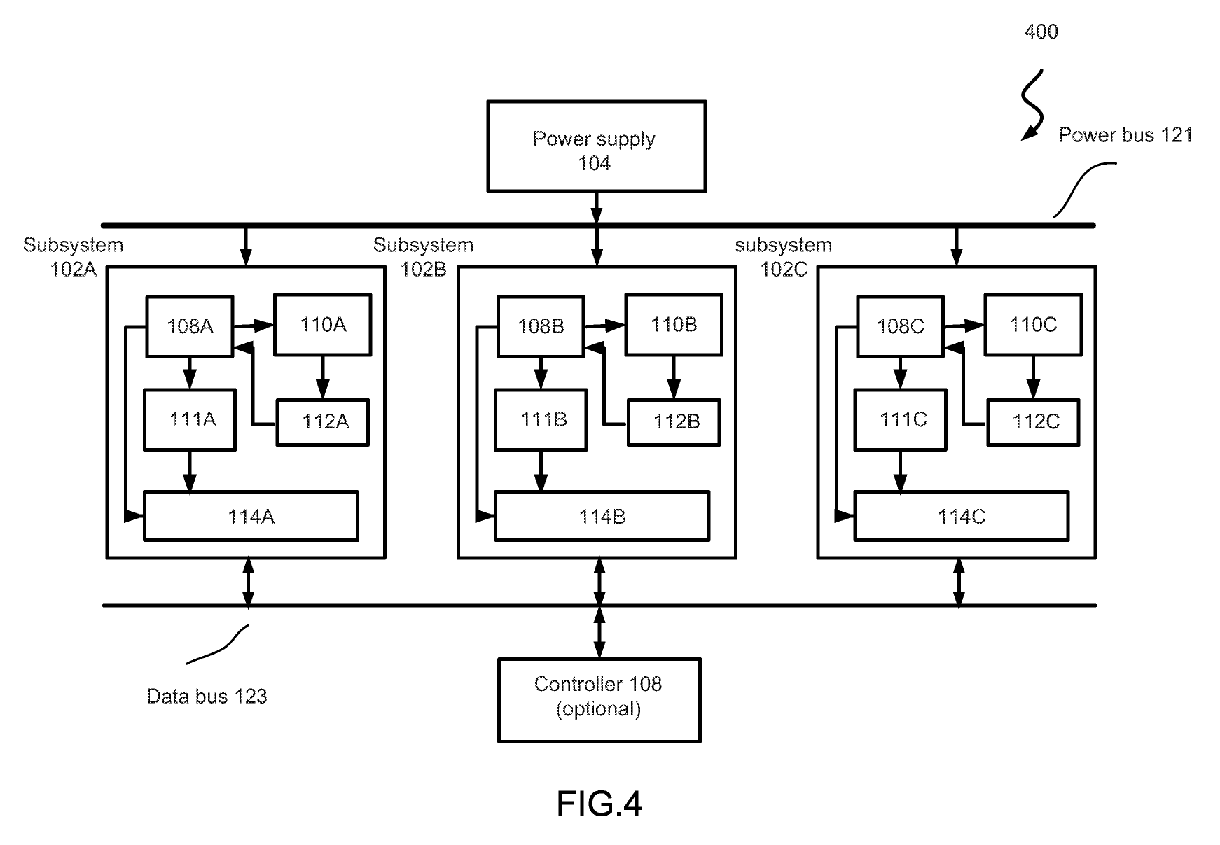

FIG. 4 is a schematic diagram illustrating an exemplary implementation of the SOC, wherein each of its subsystems includes a controller (400). As shown in FIG. 4, exemplary SOC 400 comprises more than one subsystem. In the embodiment, each of the subsystems includes a controller, a performance sensor, a first voltage regulator and a second voltage regulator. Electrical power is delivered from power supply 104 through a power bus 121 to the subsystems. The exemplary SOC 400 may further comprise a centralized controller 108 (optional). Data may be transmitted through a data bus 123. Although three subsystems are illustrated in FIG. 4, more or less subsystems may be included. System 400 may be operated under controls of the controllers in the subsystems. The subsystems may be operated independently for optimizing the power consumptions. System 400 may also be operated under control of the centralized controller 108. Data files may be stored separately in the subsystems. Data files may also be stored in centralized controller 108. In one aspect, there may be only one temperature sensor 122 included in the centralized controller 108.

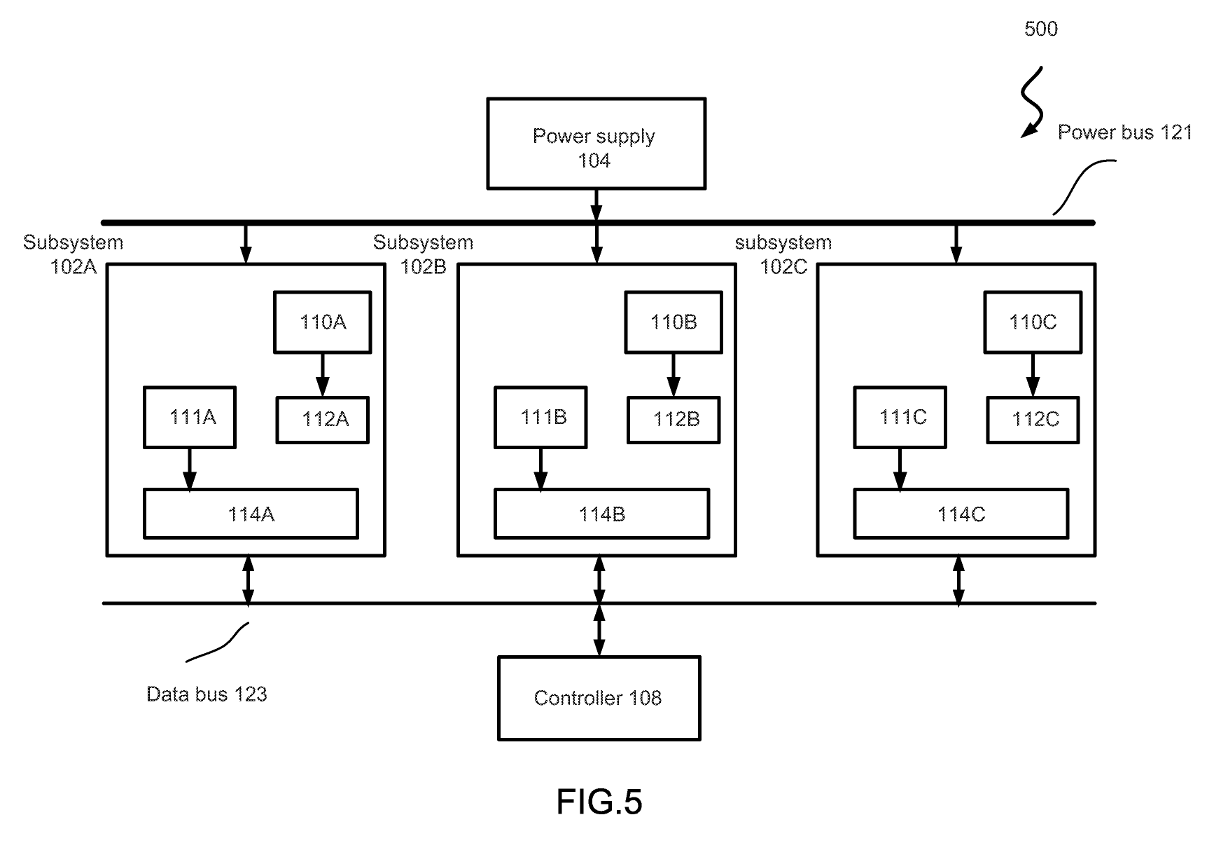

FIG. 5 illustrates another embodiment of the SOC. System 500 includes a centralized controller 108 for controlling power optimization operations of all the subsystems. There may be no controller included in the subsystems for the purpose of power optimization. This does not exclude that one or more microcontrollers included in the subsystems for performing its normal tasks. Power is delivered through power bus 121 from power supply 104 to all subsystems. Data is exchanged through data bus 123. Controller 108 may store power optimization program 120. Program 120 may be executed by controller 108 for each of the subsystems. Optimized (minimal) output voltages may be recorded in a data file stored in file storage unit 118 of controller 108. Controller 108 may be a controller already included in SOC for performing normal tasks. Controller 108 may be an independent controller dedicated for power optimizations.

While the invention has been disclosed with respect to a limited number of embodiments, numerous modifications and variations will be appreciated by those skilled in the art.

Additionally, although the invention has been described particularly with respect to system on a chip (SOC), it should be understood that the inventive concepts disclosed herein are also generally applicable to other electronic systems such as electronic systems in a printed circuit board or in multiple chip modules packaged by special technologies including but not limited to a through-silicon via (TSV) technology.

Although two voltage regulators are used, it should be understood that the inventive concepts disclosed herein are also generally applicable to more or less regulator, such as, for example, a single regulator with multiple outputs may be used.

Although a single power supply is illustrated in various embodiments, it should be understood that the inventive concepts disclosed herein are also generally applicable to a power supply with more than one bias voltage.

Although the embodiments are for power reduction in a SOC, it should be understood that the inventive concepts disclosed herein are also generally applicable to optimize other performances of the system, such as, for example, speed performances of the SOC.

It is intended that all such variations and modifications fall within the scope of the following claims:

1. A subsystem of a system on a chip (SOC) comprising:
(a) a first programmable voltage regulator coupled to at least one performance sensor,
(b) a second programmable voltage regulator coupled to system components of said subsystems;
(c) a controller coupled to said first voltage regulator and said second voltage regulator; and
(d) a means of determining minimal output voltage of said regulators for achieving minimal acceptable performances of said subsystem,
wherein said performance sensor generates one or a plurality of performance indicators, wherein said performance indicators further comprise performance limits, wherein said performance limits of said performance sensor are correlated to performance limits of said subsystem.

2. The subsystem as recited in claim 1, wherein said first voltage regulator and said second voltage regulator are identically designed and are placed within a predetermined distance in a layout of the chip.

3. The subsystem as recited in claim 2, wherein said predetermined distance further comprising a minimal distance that is allowed by design rules of the layout.

4. The subsystem as recited in claim 1, wherein said performance sensor further comprising speed sensors including oscillators and critical path delay measuring units.

5. The subsystem as recited in claim 1, wherein said performance indicators further comprising performance predictors of said subsystem, wherein said performance sensor further comprising metal oxide semiconductor field effect transistors, wherein gate length of said transistors may be intentionally sized up or sized down from a nominal value by a predetermined amount.

6. The subsystem as recited in claim 1, wherein said voltage regulators is capable of generating anyone of output voltages within a predetermined range.

7. The subsystem as recited in claim 1, wherein said controller further comprising a file storage unit.

8. The subsystem as recited in claim 7, wherein said file storage system further comprising a data file including a plurality of minimal output voltages for each of predetermined operation modes.

9. The subsystem as recited in claim 1, wherein said subsystem further comprising a temperature sensor for determining operating temperature of said subsystem, wherein said measured temperatures may be recorded in a data file stored in a file storage unit of the controller.

10. A power management method for a system on a chip (SOC) comprising a plurality of subsystems, the method comprising:
(a) sending a control signal from a controller to generate a first output voltage for a first programmable voltage regulator and to generate a second output voltage for a second programmable voltage regulator, wherein said first voltage regulator is coupled to at least one performance sensor and said second voltage regulator is coupled to system components of the subsystem;
(b) determining minimal output voltage of said first voltage regulator for achieving minimal acceptable performances of the performance sensor; and
(c) setting by the controller the output of said second voltage regulator to said minimal output voltage of said first voltage regulator.

11. The method as recited in claim 10, wherein said method further comprising determining an operation mode of said subsystem by the controller.

12. The method as recited in claim 11, wherein said method further comprising determining new minimal output voltage of said first voltage regulator after the operation mode is changed.

13. The method as recited in claim 10, wherein said method further comprising recording each of determined minimal output voltages and each of the operation modes in a data file and storing the data file in a file storage unit of the controller.

14. The method as recited in claim 13, wherein said method further comprising setting the output voltage of said second voltage regulator by the controller according to said data file.

15. The method as recited in claim 10, wherein said method further comprising determining the minimal output voltage of said first voltage regulator by progressively reducing the output voltage controlled by the controller and measuring the performance indicators of the performance sensor by the controller.

16. The method as recited in claim 10, wherein said method further comprising:
(a) reading out initial output voltages for said voltage regulators from a data file stored in a file storage unit of the controller; and
(b) determining by the controller if a power optimization program will be executed according to a history of the output voltages, said history further comprising if the output voltages have been optimized.

17. A system on a chip (SOC) comprising:
(a) a plurality of subsystems, each of the subsystems further comprising a first programmable voltage regulator and a second programmable voltage regulator, wherein said first voltage regulator is coupled to at least one performance sensor and said second voltage regulator is coupled to system components;
(b) a power bus for distributing electrical power from a power supply to the subsystems;
(c) a controller coupled to each of the subsystems through a data bus; and
(d) a means of determining minimal bias voltage for each of said subsystems that delivers minimal acceptable performances.

18. The system as recited in claim 17, wherein said performance sensor generates at least one performance indicator, wherein said performance indicator represents performances of said subsystem.

19. The system as recited in claim 17, wherein said controller further comprising a file storage unit, wherein said file storage unit further comprising a data file including a plurality of minimal bias voltages for each of predetermined operation modes, wherein said minimal bias voltages are determined during a previous test of said subsystem.

20. The system as recited in claim 17, wherein said controller is further coupled to said first voltage regulator, to said second voltage regulator and to said performance sensor.
